(19) United States
(12) Patent Application Publication
(10) Pub. No.: US 2024/0238898 A1
(43) Pub. Date: Jul. 18, 2024

(54) DEVICE AND METHOD FOR PRODUCING AN ELECTRODE

(71) Applicant: Volkswagen Aktiengesellschaft, Wolfsburg (DE)

(72) Inventor: Tobias JANSEN, Braunschweig (DE)

(73) Assignee: Volkswagen Aktiengesellschaft, Wolfsburg (DE)

(21) Appl. No.: 18/623,487

(22) Filed: Apr. 1, 2024

Related U.S. Application Data
(63) Continuation of application No. PCT/EP22/77334, filed on Sep. 30, 2022.

(30) Foreign Application Priority Data
Oct. 1, 2021 (DE) 10 2021 211 096.7

(51) Int. Cl. B23K 26/08; B23K 26/38; H01M 4/04

(52) U.S. Cl. CPC B23K 26/0838; B23K 26/38; H01M 4/04

(57) ABSTRACT

A device for producing an electrode, in particular for a lithium-ion battery cell. The device includes a belt conveyor having a belt which has, on the support face thereof, a first depression extending in the belt transverse direction, and a laser-cutting machine for cutting a strip-shaped electrode foil lying on the belt in the region of the first depression. A method for producing an electrode, in particular using a device of this kind is also provided.

This nonprovisional application is a continuation of International Application No. PCT/EP2022/077334, which was filed on Sep. 30, 2022, and which claims priority to German Patent Application No. 10 2021 211 096.7, which was filed in Germany on Oct. 1, 2021, and which are both herein incorporated by reference.

### BACKGROUND OF THE INVENTION

### Field of the Invention

The invention relates to an apparatus for manufacturing an electrode for a lithium-ion battery cell, wherein the apparatus comprises a conveyor belt and a laser cutter. Furthermore, the invention relates to a method for manufacturing an electrode, in particular via the apparatus.

### Description of Background Art

An electrically powered motor vehicle typically has a traction battery (high-voltage battery, HV battery), which supplies energy to an electric motor for powering the vehicle. In particular, an electrically powered motor vehicle includes electric vehicles that store the energy required for propulsion only in the traction battery (BEV, battery electric vehicle), electric vehicles with a range extender (REEV, range extended electric vehicle), hybrid vehicles (HEV, hybrid electric vehicle), plug-in hybrid vehicles (PHEV, plug-in hybrid electric vehicle) and/or fuel cell vehicles (FCEV, fuel cell electric vehicle) that temporarily store the electrical energy generated by a fuel cell in the traction battery.

Such a traction battery, which is designed as a lithium-ion battery, has at least one battery cell, which in turn comprises at least one anode and at least one cathode. For manufacturing such anodes or cathodes, a sheet-like and ribbon-shaped electrode foil, especially on both sides, is typically provided with a coating of active material. The coating is then compacted by at least one pair of rollers of a calender. Subsequently, the coated electrode foil is cut to size and/or cut off, forming the individual anodes or the individual cathodes.

For example, JP 2013 136 437 A is known to have an apparatus with a conveyor belt via which electrodes are separated from an electrode foil that is coated intermittently in the longitudinal (electrode foil) direction. For this purpose, the electrode foil is cut to length and cut to size in the coating-free area, forming the contact areas (contact flag, conductor flag). The belt of the conveyor belt, which is made of steel plates, has continuous holes. These are used to prevent the cutting tool from acting on the belt during the cutting process of the electrode foil.

Methods are also known in which the ribbon-shaped electrode foil is continuously coated, wherein an uncoated area for the contact sections (arrester lugs) is provided in the (electrode foil) transverse direction. However, if the contact sections are cut out first (“notching”), there is a risk, particularly at comparatively high transport speeds and/or with comparatively thin electrode foils, that the notched contact sections will fold over or bend when the electrode foil is deflected and/or when the electrode foil is wound onto a supply reel. As a result, the contact sections are embossed so that their bending stiffness is increased.

### SUMMARY OF THE INVENTION

It is therefore an object of the invention to provide a particularly suitable method and an apparatus for manufacturing an electrode for a lithium-ion battery. In particular, the method and/or the apparatus should be used to produce the electrode as quickly as possible and/or prevent damage to the belt of the conveyor belt.

The apparatus is intended and set up to manufacture an electrode for a lithium-ion battery cell. Such an electrode comprises a foil-like substrate, which is also referred to below as electrode foil. This is designed, for example, as a metal foil, in particular an aluminum foil or a copper foil, or as a coated plastic or carbon foil. Conveniently, the electrode foil, preferably on both sides, has a first section with a coating comprising active material. Furthermore, such an electrode comprises a contact section via which the electrode can be electrically connected to further electrodes, a cell outgoing conductor or the like.

The apparatus comprises a conveyor belt with a strap also known as a belt or conveyor belt. It is particularly preferable for the conveyor belt to be designed as a vacuum conveyor belt, wherein the belt suitably has continuous channels or holes, so that on one support side of the belt on which the material to be conveyed rests—in this case, the coated electrode foil and/or the electrode(s)—a vacuum can be generated and the goods can be fixed accordingly to the belt.

The belt has a first depression extending in the transverse direction of the belt on its support side (outer side, upper side). The depression is not formed continuously through the belt, i.e., it is groove or joint-like. For example, the depth of the depression is between one-quarter and three-quarters of the belt thickness. For example, the depth of the depression is between 2 mm and 10 mm.

The belt transverse direction is the direction that is oriented perpendicular to a direction of travel (conveying direction, longitudinal direction) of the belt and perpendicular to the normal of a plane stretched by the belt.

Appropriately, the belt has several first depressions which are equidistantly spaced to each other in the longitudinal direction of the belt. The distance between the first depressions defines the width of the electrode to be manufactured.

Furthermore, the apparatus includes a laser cutter (laser beam cutter). This is used to cut an electrode foil lying on the belt, i.e., an electrode being conveyed by the conveyor belt, in the area of the first depression, especially along the first depression. Thus, the electrode foil is cut along the depression. In other words, a laser beam generated by the laser cutter is guided along the depression during cutting.

The laser beam is conveniently directed at the overlay coating side, i.e., the laser cutter is directed at the depression of the overlay coating side.

For example, the laser cutter can be a laser scanner or includes several laser scanners. Alternatively, the laser cutter is a polygon laser scanner.

Via this apparatus, it is possible to cut the electrodes to length, i.e., by cutting the coated electrode foil using a transverse cut running in the transverse direction of the belt corresponding to the first depression. The laser cutter is therefore adjusted and/or oriented in such a way that the electrode foil is cut over the depression. Due to the depression, the point of action of the laser beam on the electrode foil is therefore distanced from the belt. In summary, the first depression prevents the laser beam from acting on the belt and thus reduces the risk of damaging it and/or welding the electrodes to the belt.

As compared to the state-of-the-art according to JP 2013 136 437 A mentioned above, in which continuous holes are inserted into the belt, a particularly stable belt is also provided here. The increased stability of the conveyor belt leads to lower height fluctuations in the processing plane and thus to a more homogeneous cutting edge quality.

According to a suitable further development, the belt has a second depression, which is L-shaped or stepped in shape. This second depression is provided for cutting out the contact section of the electrode from the electrode foil using the laser cutter. In other words, the second depression is for “notching”. A first section of the second depression extends from the first depression in the longitudinal direction of the belt, i.e., perpendicular to the first depression. A second section of the second depression extends parallel to the first depression towards the lateral edge of the belt, i.e., in the transverse direction of the belt, from the center of the belt to the outside of the belt.

The second depression is conveniently arranged in a decentralized manner in the belt, i.e., the belt transverse direction offset to a center plane of the belt.

If the second depression has an L-shape, it is formed from the first section as a vertical L-leg and the second section as a horizontal L-leg. If the second depression has a step form, it is formed from the first and the second in an analogous manner to the L-shape, wherein a further third section of the second depression extends from a free end of the second section to an end of another, adjacent first depression.

Expediently, the belt can comprise several second depressions, the first section of which extends in each case from one of the first depressions.

In short, the first and second depressions are integrally formed; in other words, the first depression, the second depression, and possibly further first and second depressions form a joint, uninterrupted depression in the belt.

In summary, the conveyed material, in this case the electrode foil, can be cut to size in such a way that the contact sections of the electrodes protrude in the transverse direction of the belt. For this purpose, a continuously coated electrode foil is used, which has an uncoated area for the contact section at the end of the transverse direction of the belt.

Appropriately, the laser cutter is also provided and equipped to cut the conveyed material in the area of the second depression, in particular along the second depression.

The transverse cut, i.e., the cutting of the electrode foil to length and the cutting of the contact sections together on the belt using the laser cutter, is therefore particularly advantageous. As compared to methods and apparatuses in which the contact sections are first cut out, then the electrode foil is wound up and then fed to another apparatus for cutting, the relative position of the contact sections and the transverse cut, and thus the end of the electrode in the longitudinal direction of the belt, is already defined by the joint cutting process using the laser cutter. Undesirable deviation from a predetermined relative position is thus advantageously avoided. Furthermore, when the contact sections are cut to length and cut to size in a joint cutting process on the belt, winding the electrode foil onto a supply reel after notching no longer takes place, so that advantageously, the contact sections or the uncoated area of the electrode foil no longer needs to be embossed.

The belt can have a layered structure with a carrier layer and an overlay coating for the electrode foil. In particular, the belt is formed on the basis of the layer structure.

The carrier layer can be made of a metal, a metal alloy or glass fibers or at least comprises one of these materials, so that the belt has a comparatively high dimensional stability. In addition to or as an alternative to this, materials are used for the carrier layer whose absorption coefficient for the laser radiation used is comparatively low or completely transparent. The carrier layer can form the carrier side of the belt, in other words, the carrier layer is arranged on the outer side of the belt and faces the laser cutter.

For example, the layer structure can comprise another lower layer, wherein the carrier layer can be arranged between the overlay coating and the lower layer. The lower layer is optional. Preferably, such a material is used for the lower layer, which is comparatively abrasion-resistant, flexible, thermally stable and/or easy to clean. Suitable for this purpose, for example, are a thermoplastic material or the like. A lower layer formed in this way offers tribological advantages in particular with regard to higher adhesion strength, so that there is no or at least a comparatively much reduced slip on the drive roller. In addition, wear of the belt, especially of the support layer, is or can be reduced via the lower layer, smoother operation is achieved and/or the noise level is or can be reduced.

Appropriately, the first and/or second depression can be formed via a groove-like recess in the overlay coating. For example, the recess can be continuous through the overlay coating in the direction of the normal of the belt. The first and/or second depression is therefore not formed by the carrier layer, so that it is particularly dimensionally stable.

A mark can be placed on the belt to determine the position of the first and/or second depressions for the cutting process by the laser cutter. Preferably, each of the first depressions can be marked on the belt, wherein the marks can have the same relative position to the assigned first depression. The marks are thus spaced equidistantly in the longitudinal direction of the belt.

It is expedient for the mark or marks to be arranged on the edge side, i.e., in the transverse direction of the belt on the outside, in particular on the overlay coating, so that they are not covered by the electrode foil even when the electrode foil is being conveyed.

The mark can be, for example, a pattern on the belt, in particular a QR code, or a structure of the belt, especially a hole pattern of the belt.

On the basis of the mark or marks, slippage of the electrode foil, i.e., a relative displacement of the conveyed electrode foil to the conveyor belt, which occurs particularly due to the feeding of the electrode foil onto the conveyor belt, can be determined and corrected if necessary. In this way, an inconsistency in the width of the electrodes to be manufactured, i.e., in their extension in the longitudinal direction of the belt, is avoided.

The apparatus can comprises a pick-up unit for picking up the electrodes from the belt, wherein the pick-up unit is rotationally driven. With the help of a rotationally driven pick-up unit, the electrodes can be picked up comparatively fast, so that the manufacturing rate is advantageously increased.

For example, the pick-up unit can be designed as a stacking wheel to which the electrodes are expediently fed via the conveyor belt.

Alternatively, the pick-up unit can include a gripper or suction cup, preferably more than one, via which the electrodes conveyed by the belt can be removed from the belt. The grippers or the suction cups can be moved on a circular path around a common (first) axis of rotation. Preferably additionally, each of the grippers/suction cups can be rotated around another (second) axis of rotation, which is parallel to the first axis of rotation. Based on the rotation of the respective gripper/suction cup, its speed can be adjusted to that of the conveyor belt.

Due to the respective second axis of rotation, no shear forces act on the electrode, as nothing is ground past the electrode, but instead placed on it. This also advantageously results in a comparatively high placement accuracy.

According to an example, the belt can be deflected between 90° and 180°, in particular by 135°, after a cutting area intended for laser cutting, in order to form an unloading area for the removal of the electrodes via the pick-up unit. In other words, the direction of movement (conveyance direction) of the belt in the cutting range between 90° and 180°, in particular via a pulley of the conveyor belt, is inclined against the direction of movement of the belt in the unloading area. In this way, the electrodes are advantageously removed from the belt as well as stacked or magazined using the rotationally driven pick-up unit with grippers/suction cups.

Channels can extend from the first depression and/or from the second depression for the removal of ablation products from the laser cutting process to the underside of the belt.

The depression thus has a dual function. On the one hand, it prevents the laser from acting on the belt, and on the other hand, it is used to transport the ablation products of the laser cutting process.

Another aspect of the invention relates to a method for manufacturing an electrode, which is designed as a roll-to-sheet process. In this case, single electrodes (electrode sheets) are produced from a ribbon-shaped coated electrode foil, which is unwound from a supply roll. Preferably, an apparatus is used for this purpose which is designed with a first and a second depression in one of the variants shown above.

The electrode foil can be coated throughout, with an uncoated area for the contact sections at the end in the transverse direction of the electrode.

After unwinding, the electrode foil can be fed to the conveyor belt, which is designed in particular as a vacuum conveyor belt, so that the electrode foil rests on the belt of the conveyor and is conveyed by it. In this case, the electrode strip does not protrude over the belt in the transverse direction of the belt.

Furthermore, both a contour cut to form the contact section of the electrode and a transverse cut to separate the electrode from the electrode foil are performed via a laser beam. The corresponding cutting area of the electrode foil is completely arranged over the belt.

As already shown in connection with the apparatus, the cutting to length and the notching in a common cutting process clearly define the relative position of the contact sections to the coated area and avoid a relative displacement of these to each other. In addition, it is no longer necessary to emboss the uncoated area of the electrode foil or the contact sections (arrester lugs).

The electrode can be removed from the belt via a rotationally driven pick-up unit, in particular a pick-up unit of one of the variants shown in connection with the apparatus. As a result, it is possible to pick up the electrodes from the belt and, if necessary, stack or magazine the electrodes comparatively quickly.

A further advantage of the invention, i.e., the apparatus and the method, lies in the fact that the electrode belt and the conveyor belt can be moved continuously and appropriately at a constant speed. As compared to a stop-and-go process, the processing rate is thus increased.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, an apparatus for manufacturing an electrode, wherein the apparatus has a conveyor belt for conveying an electrode foil, a laser cutter for cutting the electrode foil to form the electrode, and a rotationally driven pick-up unit for removing the electrode from the conveyor belt,

FIG. 2 schematically shows, the belt of the conveyor belt according to an example in a top view, wherein the belt has depressions extending in the transverse direction of the belt,

FIG. 3 schematically shows, the belt of the conveyor belt according to an example in a top view, wherein the belt also has a second depression extending in steps,

FIGS. 4a and 4b schematically show, a cross-section through the belt according to the section plane IVa-IVa or along the section plane of IVb-IVb of FIG. 3,

FIG. 5 shows on the basis of a flowchart, a process for manufacturing an electrode, in particular via the apparatus of FIG. 1 having the belt according to FIG. 3, and

FIG. 6 schematically shows, a coated electrode foil and an electrode cut out of it.

### DETAILED DESCRIPTION

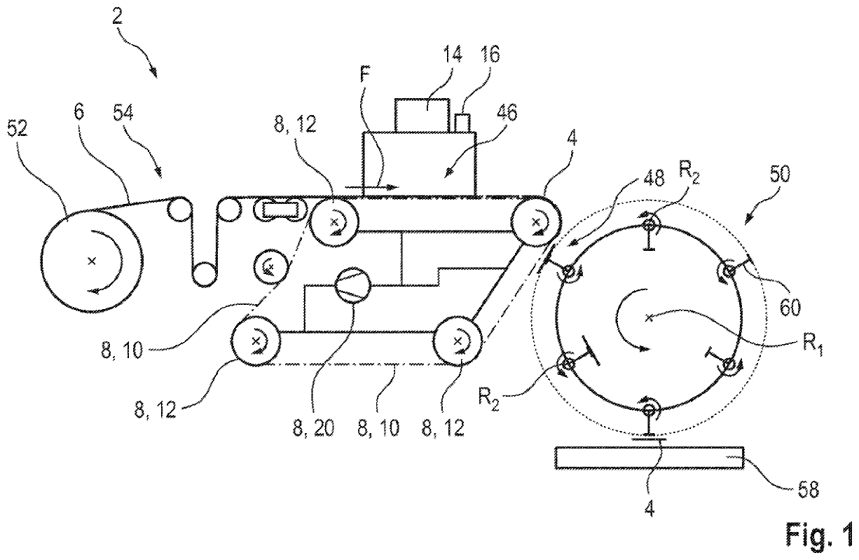

FIG. 1 shows a schematic side view of an apparatus 2 for manufacturing an electrode 4 for a lithium-ion battery cell. The apparatus 2 is set up to produce at least one, preferably a plurality of electrodes, from a ribbon-shaped electrode foil 6 (see also FIG. 6) in a roll-to-sheet process.

The apparatus 2 comprises a conveyor belt 8 designed as a vacuum conveyor belt, the belt 10 of which is guided and/or driven by pulleys 12. In addition, the apparatus 2 comprises a laser cutter 14 for cutting the electrode foil 6, which is conveyed and resting on the belt 10. The apparatus includes a removal unit 16 on the laser cutter side with respect to the belt 10 for the removal of ablation products resulting from the cutting process. The belt is shown in FIG. 1 in dotted lines for better identification of the electrode foil 6.

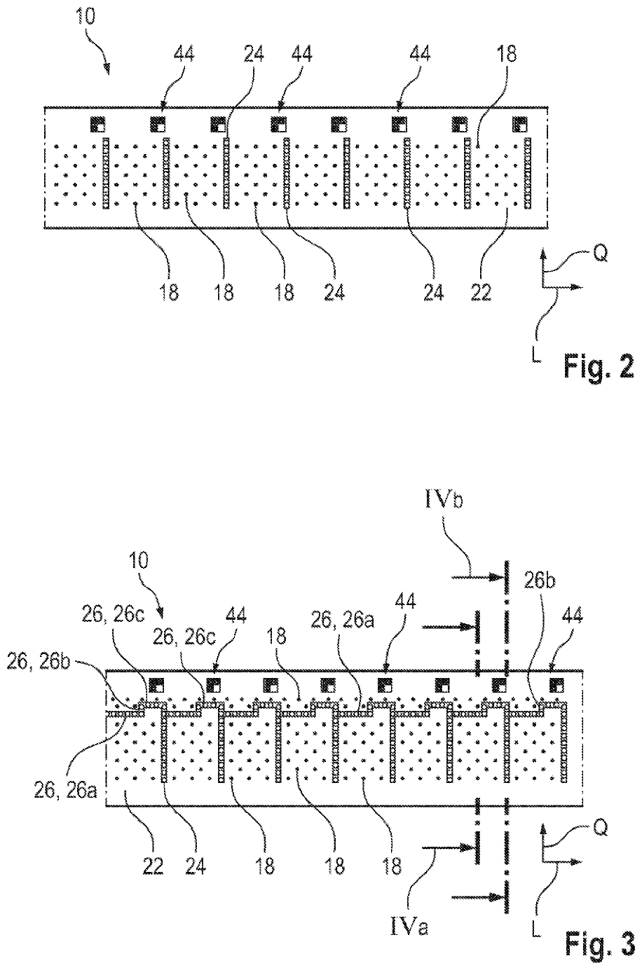

FIGS. 2 and 3 schematically show a first variant and a second variant of the belt 10 in a top view. In both variants, the belt 10 has continuous vacuum channels 18, so that a vacuum can be generated on the overlay coating side 22 of the belt 10 via a pump 20, or via a compressor or the like, so that the electrode foil 6 or the electrode(s) 4 can be fixed on the belt 10. Furthermore, both variants have in common that the belt 10 has a number of first depressions 24 extending in the transverse direction Q of the belt on its overlay coating side 22. The first depressions 24 are arranged equidistantly in the belt 10, wherein the width b of the electrodes 4 to be produced is defined on the basis of the distance of the first depressions 24 to each other.

In the second variant of the belt 10 according to FIG. 3, said belt has a number of second depressions 26 in addition to the first depression 24. Each of the second depressions 26 is formed in steps. The second depressions 26 extend from one of the first depressions 24 to the adjacent first depression 24. A first section 26a of the respective second depression 26 extends from the respective first depression 24 in the longitudinal direction L of the belt 10. A second section 26b of the second depression 26 extends from the end of the first section 26a, which faces away from the first depression 24, in the transverse direction of the belt Q from a middle plane of the belt 10. To sum up, the first and second sections 26a, 26b form an L-shaped depression, wherein the first section 26a forms the vertical L-leg and the second section 26b forms the horizontal L-leg. The first section 26a extends continuously from the first section 24 to the second section 26b.

A third section 26c of the second depression 26 extends in the longitudinal direction of the belt L, forming a stepped form of the second depression 26 from the end of the second section 26b facing away from the first section 26a to the adjacent first depression 24. The third section 26c is optional. In particular, this is not present if the height h_{B} of the uncoated section 28 of the electrode foil 6 corresponds to a specified height h_{K} of the contact section 30, i.e., of the expansion of the contact section 30 in the electrode foil transverse direction Q_{E} (see also FIG. 6).

The first depressions 24 and the second depressions 26 form a periodically repeating pattern in the longitudinal direction L of the belt, along which the electrode foil 6 conveyed via the belt 10 is cut via the laser cutter 14. In other words, the electrode foil 6 is cut in the area, especially along the first and second depressions, forming the electrode(s) using the laser cutter 14. The first depressions 24, which extend in the transverse direction Q of the belt, are provided for a transverse cut, i.e., for cutting the electrode foil 6 to length. Accordingly, the second depressions 26 are provided for cutting out the contact section 30 of the respective electrode 4. Due to the depressions 24, 26, the electrode foil 6 is spaced from the belt 10 in the area where it is cut by the laser cutter 14, so that the laser beam emitted by the laser cutter 14 is prevented from acting on the belt 10.

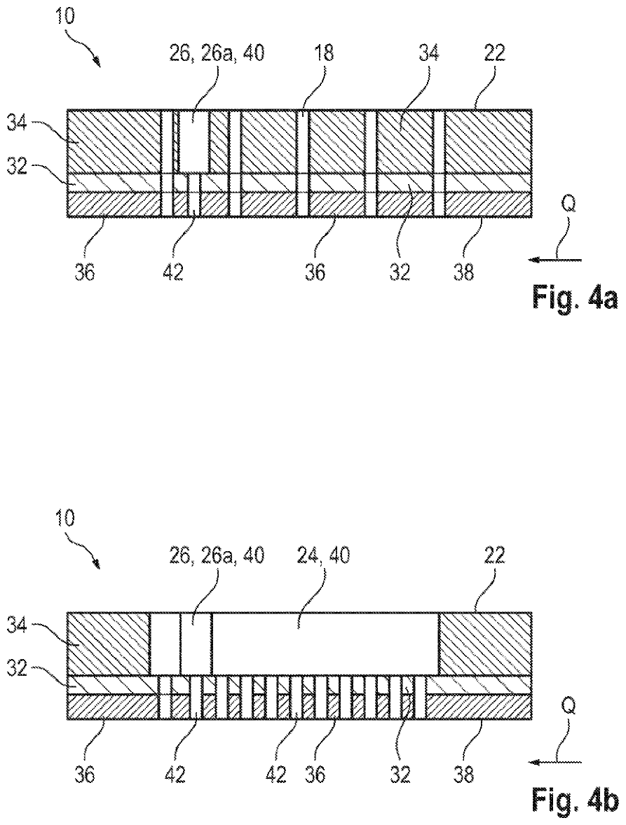

As can be seen in particular in FIGS. 4a and 4b, the belt 10 has a layered structure with a carrier layer 32, which is formed of a metal, an alloy, glass fibers, or a material whose absorption coefficient for the laser radiation used is very low or completely transparent. On one side of the carrier layer, an overlay coating 34 is placed. The carrier layer forms the overlay coating side 22 of the belt, on which the electrode foil 6 rests during conveying. On the other side of the carrier layer 32, a lower layer 36 is optionally arranged, which is in contact with the pulleys 12.

The first depression 24 and the second depression 26 are groove-like. Thus, the first depression 24 and the second depression 26 extend from the overlay coating side 22 to a (belt) underside 38. Each of the first depressions 24 and each of the second depressions 26 are thus formed via a groove-like depression 40 of the overlay coating 34. In other words, each of the first and second depressions 24, 26 extends only within the overlay coating 34.

Furthermore, channels 42 extend from the depressions 24,26 through the belt 10, i.e., through the carrier layer and through the lower layer. These channels 42 are used for the removal of ablation products from the laser cutting process.

For the cutting of the electrode foil 6, a mark 44 is arranged in an edge area of the belt 10 for each first depression 24. As an example, this is designed as a QR code and is used to determine the position of the first depression 24 for the cutting process, since the depressions 24, 26 are covered by the electrode foil 6. Accordingly, the laser cutter 14 comprises an acquisition unit, for example a camera and an evaluation unit, on the basis of which the position of the first depressions 24, 26 and thus the alignment or orientation of the laser beam generated by the laser beam unit 14 for cutting is adjusted.

As shown in FIG. 1, following a cutting area 46 in which the electrode foil 6 is cut, the belt 10 is deflected via a pulley 12 by an angle between 90° and 180°, here by way of example by 135°. In this way, a pick-up area 48 is formed, in which a rotationally driven pick-up unit 50 can pick up the electrodes 4 from the belt 10.

The pick-up unit 50 places the collected electrodes 4 on a stack in a magazine 58.

The pick-up unit 50 comprises a number of grippers or suction cups 60, which are used to remove the electrodes 4 conveyed by the belt 10 from the belt 10. The grippers or the suction cups 60 can be moved on a circular path around a common first axis of rotation R1 (rotational axis). In addition, each of the grippers/suction cups can be rotated around a second rotational axis R₂, which is parallel to the first axis of rotation R₁ and runs along the circular path. Based on the rotation of the respective gripper/suction cup around its second axis of rotation R₂, its speed can be adjusted to that of the belt 10. The first axis of rotation R₁ of the pick-up unit 50 is always parallel to the transverse direction Q of the belt 10. In FIG. 1, the rotation around the second axis of rotation R₂ is shown only in one direction of rotation—in the view of FIG. 1 it is counterclockwise. Preferably, the respective gripper/suction cup can be rotated in both directions of rotation around the second rotation axis R_{2.}

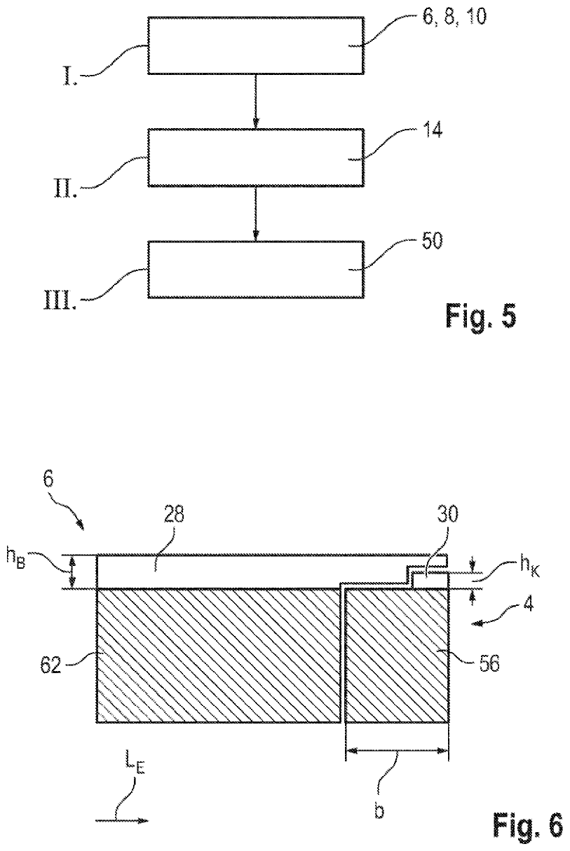

FIG. 5 shows a flow diagram which summarizes a roll-to-sheet manufacturing process of an electrode 4 using the apparatus shown above.

In a first step I, the ribbon-shaped electrode foil 6 (see FIG. 6) is unwound from a supply reel 52 via an unwinder 54 and fed to the conveyor belt 8.

The ribbon-shaped electrode foil 6 is conveyed on the belt 10 of the conveyor belt 8 in the conveying direction F to the cutting area 46, where the electrode foil 6 is provided with a contour cut to form the contact section 30 of the respective electrode 4 as well as with a transverse cut for separating the respective electrode 4 from the electrode foil 6 using the laser cutter 14 (step II.). The belt 10 is preferably moved at a constant speed.

Since the electrode foil 6 does not protrude beyond the belt 10 in the transverse direction Q of the belt, the corresponding cutting area for the transverse cut and for the contour cut forming the contact section 30 is completely located over the belt.

The remnants of the electrode foil 6 that remain during cutting are removed from the conveyor belt 8 using a cleaning concept.

Subsequently, the cut-out electrode 4 is conveyed from the cutting area 46 to the pick-up area 48, where the electrode 4 is removed from the belt 10 via the rotationally driven pick-up unit 50 and then deposited and stacked in the magazine 58 using the pick-up unit 50 (step III.).

FIG. 6 shows a schematic top view of the coated electrode foil 6 and an electrode 4 cut out of this electrode foil 6 using the apparatus 2 and/or the method. The ribbon-shaped electrode foil 6 has a first area 62, in which said foil is coated, preferably on both sides. The electrode foil 6 is coated continuously, i.e., without interruption, in the first area 62 with respect to the electrode belt longitudinal direction L. At the end, in the electrode foil transverse direction Q_{E} (electrode strip transverse direction Q_{E}) that is perpendicular to the electrode belt longitudinal direction L_{E}, the electrode foil 6 has the uncoated area 28 intended for the formation of the contact sections 30. After the transverse cut along the first depression 24 and the contour cut along the second depression 26, the electrode 4 is formed, i.e., manufactured, with the contact section 30 and a coated section 56.

The invention is not limited to the examples and embodiments described above. On the contrary, other variants of the invention can also be derived from it by the skilled person without departing from the subject matter of the invention. In particular, all the individual features described in connection with the embodiments can also be combined with each other in other ways without departing from the subject matter of the invention.

What is claimed is:

1. An apparatus to manufacture an electrode, in particular for a lithium-ion battery cell, the apparatus comprising:
a conveyor belt having a belt that has a first depression extending in a transverse direction of the belt on its overlay coating side; and
a laser cutter to cut an electrode foil lying on the belt in an area of the first depression.

2. The apparatus according to claim 1, wherein the belt has an L-shaped or stepped second depression for cutting out a contact section via the laser cutter, with a first section of the second depression extending from the first depression in the longitudinal direction of the belt, and a second section of the second depression substantially parallel to the first depression towards a lateral edge of the belt.

3. The apparatus according to claim 1, wherein the belt has a layered structure with a carrier layer and with an overlay coating layer for the electrode foil.

4. The apparatus according to claim 3, wherein the first depression and/or the second depression is formed via a groove-like depression of the overlay coating layer.

5. The apparatus according to claim 1, wherein there is a mark on the belt to determine a position of the first depression for the cutting process by the laser cutter.

6. The apparatus according to claim 1, further comprising a pick-up unit for picking up the electrodes from the belt, and wherein the pick-up unit is rotationally driven.

7. The apparatus according to claim 6, wherein, following a cutting area, the belt is deflected between 90° and 180° or by 135° to form a pick-up area for picking up the electrodes via the pick-up unit.

8. The apparatus according to claim 1, wherein channels for the removal of ablation products from the laser cutting process extend continuously from the first depression and/or from the second depression to an underside of the belt.

9. A roll-to-sheet method for manufacturing an electrode from an electrode foil using the apparatus according to claim 1, the method comprising:
conveying a ribbon-shaped electrode foil on the belt of the conveyor belt;
performing both a contour cut to form the contact section of the electrode and a transverse cut to separate the electrode from the electrode foil via a laser beam; and
arranging the cutting area of the electrode foil entirely over the belt.

10. The method according to claim 9, wherein the electrode is removed from the belt via a rotationally driven pick-up unit.

11. The apparatus according to claim 1, wherein the conveyor belt is a vacuum conveyor belt.
